(19) United States
(12) Patent Application Publication
(10) Pub. No.: US 2026/0281454 A1
(43) Pub. Date: Sep. 17, 2026

(54) IMAGE ENCODING/DECODING METHOD AND APPARATUS, AND RECORDING MEDIUM STORING BITSTREAMS

(71) Applicant: LG ELECTRONICS INC., Seoul (KR)

(72) Inventors: Chulkeun KIM, Seoul (KR); Jaehyun LIM, Seoul (KR); Junghak NAM, Seoul (KR); Jangwon LEE, Seoul (KR); Seunghwan KIM, San Diego, CA (US); Hendry TAN, San Diego, CA (US)

(73) Assignee: LG ELECTRONICS INC., Seoul (KR)

(21) Appl. No.: 19/568,328

(22) Filed: Mar. 16, 2026

Related U.S. Application Data
(60) Provisional application No. 63/772,721, filed on Mar. 16, 2025.

(51) Int. Cl. H04N 19/70; H04N 19/169

(52) U.S. Cl. CPC H04N 19/70; H04N 19/188

(57) ABSTRACT

An image decoding method and apparatus according to the present disclosure may receive a bitstream including an encoded video picture and reconstruct an encoded video picture included in a bitstream. Here, a bitstream may include an artificial intelligence (AI) usage restriction supplemental enhancement information (SEI) message. The AI usage restriction SEI message may include AI usage restriction information representing a restriction on AI usage and context information representing a context for the AI usage restriction information.

### CROSS-REFERENCE TO RELATED APPLICATION(S)

Pursuant to 35 U.S.C. § 119(e), this application claims the benefit of U.S. Provisional Patent Application No. 63/772,721, filed on Mar. 16, 2025, the contents of which is hereby incorporated by reference herein in its entirety.

### TECHNICAL FIELD

The present disclosure relates to an image encoding/decoding method and apparatus, and a recording medium storing a bitstream.

### BACKGROUND

Recently, the demand for high-resolution and high-quality images such as HD (High Definition) images and UHD (Ultra High Definition) images has been increasing in various application fields, and accordingly, highly efficient image compression technologies are being discussed.

There are a variety of technologies such as inter-prediction technology that predicts a pixel value included in a current picture from a picture before or after a current picture with video compression technology, intra-prediction technology that predicts a pixel value included in a current picture by using pixel information in a current picture, entropy coding technology that allocates a short sign to a value with high appearance frequency and a long sign to a value with low appearance frequency, etc. and these image compression technologies may be used to effectively compress image data and transmit or store it.

### SUMMARY

The present disclosure provides a method and an apparatus for configuring AI usage restrictions.

The present disclosure provides a method and an apparatus for signaling AI usage restrictions.

The present disclosure provides a method and an apparatus for applying AI usage restrictions to various standard technologies.

An image decoding method and apparatus according to the present disclosure may receive a bitstream including an encoded video picture and reconstruct an encoded video picture included in the bitstream. The bitstream may include an artificial intelligence (AI) usage restriction supplemental enhancement information (SEI) message. The AI usage restriction SEI message may include AI usage restriction information representing a restriction on AI usage and context information representing a context for the AI usage restriction information.

In an image decoding method and apparatus according to the present disclosure, a predetermined list may be constructed with payload type values for SEI messages. The payload type values within the list may include a specific value representing a payload type for the AI usage restriction SEI message.

In an image decoding method and apparatus according to the present disclosure, the specific value representing the payload type for the AI usage restriction SEI message may be 225.

In an image decoding method and apparatus according to the present disclosure, the list may relate to SEI messages associated with a single layer within a multi-layer bitstream.

In an image decoding method and apparatus according to the present disclosure, the list may relate to SEI messages associated with a video coding layer (VCL) NAL unit.

In an image decoding method and apparatus according to the present disclosure, the list may relate to SEI messages subject to specific picture unit representation constraints.

In an image decoding method and apparatus according to the present disclosure, based on whether the AI usage restriction SEI message is included in a scalable nesting SEI message, it may be determined to which dependency representations of a current access unit (AU) the AI usage restriction SEI message is applied.

In an image decoding method and apparatus according to the present disclosure, when the AI usage restriction SEI message is not included in the scalable nesting SEI message, the AI usage restriction SEI message may be applied to dependency representations of the current AU having a dependency identifier of 0. When the AI usage restriction SEI message is included in the scalable nesting SEI message, the AI usage restriction SEI message may be applied to dependency representations of the current AU having the same dependency identifier as an SEI dependency identifier signaled through a bitstream.

In an image decoding method and apparatus according to the present disclosure, the AI usage restriction SEI message may be restricted from being included in the same SEI NAL unit as a scalable video coding-related SEI message.

An image encoding method and apparatus according to the present disclosure may receive an encoded video picture, encode the received video picture to generate video information related to the video picture, generate an artificial intelligence (AI) usage restriction supplemental enhancement information (SEI) message and generate a bitstream including the video information and the AI usage restriction SEI message. The AI usage restriction SEI message may include AI usage restriction information representing a restriction on AI usage and context information representing a context for the AI usage restriction information. The AI usage restriction SEI message may be encoded in a network abstraction layer (NAL) unit of the bitstream.

A computer-readable digital storage medium storing encoded video/image information that causes performing the image decoding method by a decoding apparatus according to the present disclosure is provided.

A computer-readable digital storage medium storing video/image information generated according to the image encoding method according to the present disclosure is provided.

A method and an apparatus for transmitting video/image information generated according to an image encoding method according to the present disclosure are provided.

According to the present disclosure, by defining AI usage restrictions, it is possible to easily confirm a restriction on AI usage applied to a bitstream and a context for a corresponding restriction.

According to the present disclosure, AI usage restrictions may be implemented to conform to an intended function and purpose in each standard.

### BRIEF DESCRIPTION OF THE DRAWINGS

FIG. 1 shows a video/image coding system according to the present disclosure.

FIG. 2 shows a schematic block diagram of an encoding apparatus to which an embodiment of the present disclosure is applicable and encoding of video/image signals is performed.

FIG. 3 shows a schematic block diagram of a decoding apparatus to which an embodiment of the present disclosure is applicable and decoding of video/image signals is performed.

FIG. 4 illustrates a method for reconstructing a video picture performed by the decoding apparatus 300 according to the present disclosure.

FIG. 5 illustrates a schematic configuration of the decoding apparatus 300 that performs a method for reconstructing a video picture according to the present disclosure.

FIG. 6 illustrates a method for generating a bitstream performed by the encoding apparatus 200 according to the present disclosure.

FIG. 7 illustrates a schematic configuration of the encoding apparatus 200 that performs a method for generating a bitstream according to the present disclosure.

FIG. 8 shows an example of a contents streaming system to which embodiments of the present disclosure may be applied.

### DETAILED DESCRIPTION

Since the present disclosure may make various changes and have several embodiments, specific embodiments will be illustrated in a drawing and described in detail in a detailed description. However, it is not intended to limit the present disclosure to a specific embodiment, and should be understood to include all changes, equivalents and substitutes included in the spirit and technical scope of the present disclosure. While describing each drawing, similar reference numerals are used for similar components.

A term such as first, second, etc. may be used to describe various components, but the components should not be limited by the terms. The terms are used only to distinguish one component from other components. For example, the first component may be referred to as the second component without departing from the scope of a right of the present disclosure, and similarly, the second component may also be referred to as the first component. A term of and/or includes any of a plurality of related stated items or a combination of a plurality of related stated items.

When a component is referred to as “being connected” or “being linked” to another component, it should be understood that it may be directly connected or linked to another component, but another component may exist in the middle. On the other hand, when a component is referred to as “being directly connected” or “being directly linked” to another component, it should be understood that there is no another component in the middle.

A term used in this application is just used to describe a specific embodiment, and is not intended to limit the present disclosure. Singular expressions include plural expressions unless the context clearly dictates otherwise. In this application, it should be understood that a term such as “include” or “have”, etc. is intended to designate the presence of features, numbers, steps, operations, components, parts or combinations thereof described in the specification, but does not exclude in advance the possibility of presence or addition of one or more other features, numbers, steps, operations, components, parts or combinations thereof.

The present disclosure relates to video/image coding. For example, a method/an embodiment disclosed herein may be applied to a method disclosed in the versatile video coding (VVC) standard. In addition, a method/an embodiment disclosed herein may be applied to a method disclosed in the essential video coding (EVC) standard, the AOMedia Video 1 (AV1) standard, the 2nd generation of audio video coding standard (AVS2) or the next-generation video/image coding standard (ex. H.267 or H.268, etc.).

This specification proposes various embodiments of video/image coding, and unless otherwise specified, the embodiments may be performed in combination with each other.

Herein, a video may refer to a set of a series of images over time. A picture generally refers to a unit representing one image in a specific time period, and a slice/a tile is a unit that forms part of a picture in coding. A slice/a tile may include at least one coding tree unit (CTU). One picture may consist of at least one slice/tile. One tile is a rectangular region composed of a plurality of CTUs within a specific tile column and a specific tile row of one picture. A tile column is a rectangular region of CTUs having the same height as that of a picture and a width designated by a syntax requirement of a picture parameter set. A tile row is a rectangular region of CTUs having a height designated by a picture parameter set and the same width as that of a picture. CTUs within one tile may be arranged consecutively according to CTU raster scan, while tiles within one picture may be arranged consecutively according to raster scan of a tile. One slice may include an integer number of complete tiles or an integer number of consecutive complete CTU rows within a tile of a picture that may be included exclusively in a single NAL unit. Meanwhile, one picture may be divided into at least two sub-pictures. A sub-picture may be a rectangular region of at least one slice within a picture.

A pixel, a pixel or a pel may refer to the minimum unit that constitutes one picture (or image). In addition, ‘sample’ may be used as a term corresponding to a pixel. A sample may generally represent a pixel or a pixel value, and may represent only a pixel/a pixel value of a luma component, or only a pixel/a pixel value of a chroma component.

A unit may represent a basic unit of image processing. A unit may include at least one of a specific region of a picture and information related to a corresponding region. One unit may include one luma block and two chroma (ex. cb, cr) blocks. In some cases, a unit may be used interchangeably with a term such as a block or an region, etc. In a general case, a M×N block may include a set (or an array) of transform coefficients or samples (or sample arrays) consisting of M columns and N rows.

Herein, “A or B” may refer to “only A”, “only B” or “both A and B.” In other words, herein, “A or B” may be interpreted as “A and/or B.” For example, herein, “A, B or C” may refer to “only A”, “only B”, “only C” or “any combination of A, B and C)”.

A slash (/) or a comma used herein may refer to “and/or.” For example, “A/B” may refer to “A and/or B.” Accordingly, “A/B” may refer to “only A”, “only B” or “both A and B.” For example, “A, B, C” may refer to “A, B, or C”.

Herein, “at least one of A and B” may refer to “only A”, “only B” or “both A and B”. In addition, herein, an expression such as “at least one of A or B” or “at least one of A and/or B” may be interpreted in the same way as “at least one of A and B”.

In addition, herein, “at least one of A, B and C” may refer to “only A”, “only B”, “only C”, or “any combination of A, B and C”. In addition, “at least one of A, B or C” or “at least one of A, B and/or C” may refer to “at least one of A, B and C”.

In addition, a parenthesis used herein may refer to “for example.” Specifically, when indicated as “prediction (intra prediction)”, “intra prediction” may be proposed as an example of “prediction”. In other words, “prediction” herein is not limited to “intra prediction” and “intra prediction” may be proposed as an example of “prediction.” In addition, even when indicated as “prediction (i.e., intra prediction)”, “intra prediction” may be proposed as an example of “prediction.”

Herein, a technical feature described individually in one drawing may be implemented individually or simultaneously.

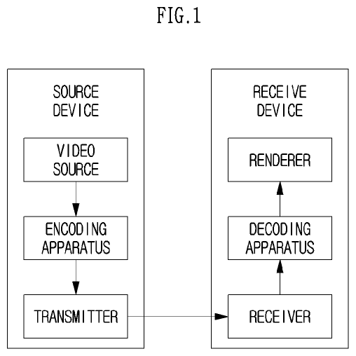

FIG. 1 shows a video/image coding system according to the present disclosure.

Referring to FIG. 1, a video/image coding system may include the first device (a source device) and the second device (a receiving device).

A source device may transmit encoded video/image information or data in a form of a file or streaming to a receiving device through a digital storage medium or a network. The source device may include a video source, an encoding apparatus and a transmission unit. The receiving device may include a reception unit, a decoding apparatus and a renderer. The encoding apparatus may be referred to as a video/image encoding apparatus and the decoding apparatus may be referred to as a video/image decoding apparatus. A transmitter may be included in an encoding apparatus. A receiver may be included in a decoding apparatus. A renderer may include a display unit, and a display unit may be composed of a separate device or an external component.

A video source may acquire a video/an image through a process of capturing, synthesizing or generating a video/an image. A video source may include a device of capturing a video/an image and a device of generating a video/an image. A device of capturing a video/an image may include at least one camera, a video/image archive including previously captured videos/images, etc. A device of generating a video/an image may include a computer, a tablet, a smartphone, etc. and may (electronically) generate a video/an image. For example, a virtual video/image may be generated through a computer, etc., and in this case, a process of capturing a video/an image may be replaced by a process of generating related data.

An encoding apparatus may encode an input video/image. An encoding apparatus may perform a series of procedures such as prediction, transform, quantization, etc. for compression and coding efficiency. Encoded data (encoded video/image information) may be output in a form of a bitstream.

A transmission unit may transmit encoded video/image information or data output in a form of a bitstream to a reception unit of a receiving device through a digital storage medium or a network in a form of a file or streaming. A digital storage medium may include various storage media such as USB, SD, CD, DVD, Blu-ray, HDD, SSD, etc. A transmission unit may include an element for generating a media file through a predetermined file format and may include an element for transmission through a broadcasting/communication network. A reception unit may receive/extract the bitstream and transmit it to a decoding apparatus.

A decoding apparatus may decode a video/an image by performing a series of procedures such as dequantization, inverse transform, prediction, etc. corresponding to an operation of an encoding apparatus.

A renderer may render a decoded video/image. A rendered video/image may be displayed through a display unit.

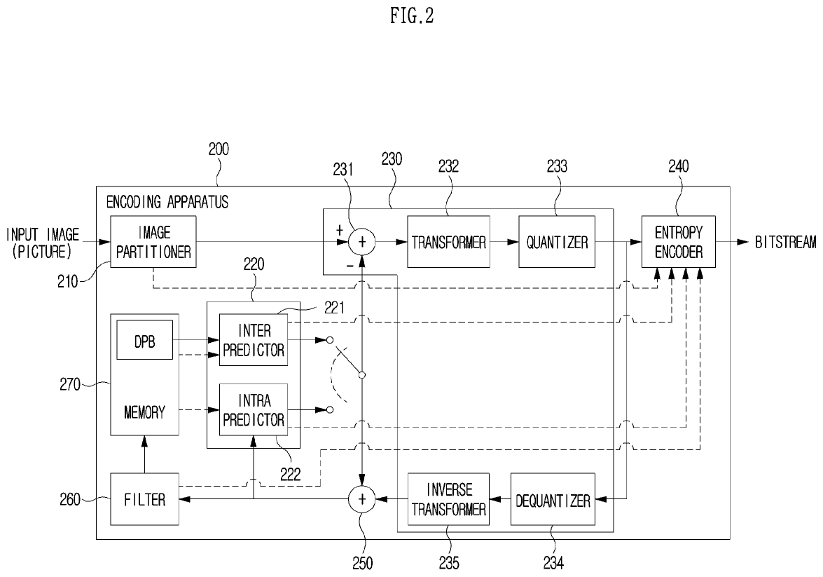

FIG. 2 shows a rough block diagram of an encoding apparatus to which an embodiment of the present disclosure may be applied and encoding of a video/image signal is performed.

Referring to FIG. 2, an encoding apparatus 200 may be composed of an image partitioner 210, a predictor 220, a residual processor 230, an entropy encoder 240, an adder 250, a filter 260 and a memory 270. A predictor 220 may include an inter predictor 221 and an intra predictor 222. A residual processor 230 may include a transformer 232, a quantizer 233, a dequantizer 234 and an inverse transformer 235. A residual processor 230 may further include a subtractor 231. An adder 250 may be referred to as a reconstructor or a reconstructed block generator. The above-described image partitioner 210, predictor 220, residual processor 230, entropy encoder 240, adder 250 and filter 260 may be configured by at least one hardware component (e.g., an encoder chipset or a processor) according to an embodiment. In addition, a memory 270 may include a decoded picture buffer (DPB) and may be configured by a digital storage medium. The hardware component may further include a memory 270 as an internal/external component.

An image partitioner 210 may partition an input image (or picture, frame) input to an encoding apparatus 200 into at least one processing unit. As an example, the processing unit may be referred to as a coding unit (CU). In this case, a coding unit may be partitioned recursively according to a quad-tree binary-tree ternary-tree (QTBTTT) structure from a coding tree unit (CTU) or the largest coding unit (LCU).

For example, one coding unit may be partitioned into a plurality of coding units with a deeper depth based on a quad tree structure, a binary tree structure and/or a ternary structure. In this case, for example, a quad tree structure may be applied first and a binary tree structure and/or a ternary structure may be applied later. Alternatively, a binary tree structure may be applied before a quad tree structure. A coding procedure according to this specification may be performed based on a final coding unit that is no longer partitioned. In this case, based on coding efficiency, etc. according to an image characteristic, the largest coding unit may be directly used as a final coding unit, or if necessary, a coding unit may be recursively partitioned into coding units of a deeper depth, and a coding unit with an optimal size may be used as a final coding unit. Here, a coding procedure may include a procedure such as prediction, transform, and reconstruction, etc. described later.

As another example, the processing unit may further include a prediction unit (PU) or a transform unit (TU). In this case, the prediction unit and the transform unit may be divided or partitioned from a final coding unit described above, respectively. The prediction unit may be a unit of sample prediction, and the transform unit may be a unit for deriving a transform coefficient and/or a unit for deriving a residual signal from a transform coefficient.

In some cases, a unit may be used interchangeably with a term such as a block or an region, etc. In a general case, a M×N block may represent a set of transform coefficients or samples consisting of M columns and N rows. A sample may generally represent a pixel or a pixel value, and may represent only a pixel/a pixel value of a luma component, or only a pixel/a pixel value of a chroma component. A sample may be used as a term that makes one picture (or image) correspond to a pixel or a pel.

An encoding apparatus 200 may subtract a prediction signal (a prediction block, a prediction sample array) output from an inter predictor 221 or an intra predictor 222 from an input image signal (an original block, an original sample array) to generate a residual signal (a residual signal, a residual sample array), and a generated residual signal is transmitted to a transformer 232. In this case, a unit that subtracts a prediction signal (a prediction block, a prediction sample array) from an input image signal (an original block, an original sample array) within an encoding apparatus 200 may be referred to as a subtractor 231.

A predictor 220 may perform prediction on a block to be processed (hereinafter, referred to as a current block) and generate a predicted block including prediction samples for the current block. A predictor 220 may determine whether intra prediction or inter prediction is applied in a unit of a current block or a CU. A predictor 220 may generate various information on prediction such as prediction mode information, etc. and transmit it to an entropy encoder 240 as described later in a description of each prediction mode. Information on prediction may be encoded in an entropy encoder 240 and output in a form of a bitstream.

An intra predictor 222 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. A nondirectional mode may include at least one of a DC mode or a planar mode. A directional mode may include 33 directional modes or 65 directional modes according to a detail level of a prediction direction. However, it is an example, and more or less directional modes may be used according to a configuration. An intra predictor 222 may determine a prediction mode applied to a current block by using a prediction mode applied to a neighboring block.

An inter predictor 221 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. A reference picture including the reference block and a reference picture including the temporal neighboring block may be the same or different. The temporal neighboring block may be referred to as a collocated reference block, a collocated CU (colCU), etc., and a reference picture including the temporal neighboring block may be referred to as a collocated picture (colPic). For example, an inter predictor 221 may configure a motion information candidate list based on neighboring blocks and generate information indicating which candidate is used to derive a motion vector and/or a reference picture index of the current block. Inter prediction may be performed based on various prediction modes, and for example, for a skip mode and a merge mode, an inter predictor 221 may use motion information of a neighboring block as motion information of a current block. For a skip mode, unlike a merge mode, a residual signal may not be transmitted. For a motion vector prediction (MVP) mode, a motion vector of a neighboring block is used as a motion vector predictor and a motion vector difference is signaled to indicate a motion vector of a current block.

A predictor 220 may generate a prediction signal based on various prediction methods described later. For example, a predictor may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, a sample value within a picture may be signaled based on information on a palette table and a palette index. A prediction signal generated through the predictor 220 may be used to generate a reconstructed signal or a residual signal.

A transformer 232 may generate transform coefficients by applying a transform technique to a residual signal. For example, a transform technique may include at least one of Discrete Cosine Transform (DCT), Discrete Sine Transform (DST), Karhunen-Loève Transform (KLT), Graph-Based Transform (GBT) or Conditionally Non-linear Transform (CNT). Here, GBT refers to transform obtained from this graph when relationship information between pixels is expressed as a graph. CNT refers to transform obtained based on generating a prediction signal by using all previously reconstructed pixels. In addition, a transform process may be applied to a square pixel block in the same size or may be applied to a non-square block in a variable size.

A quantizer 233 may quantize transform coefficients and transmit them to an entropy encoder 240 and an entropy encoder 240 may encode a quantized signal (information on quantized transform coefficients) and output it as a bitstream. Information on the quantized transform coefficients may be referred to as residual information. A quantizer 233 may reorder quantized transform coefficients in a block form into a 1D vector form based on coefficient scan order, and may generate information on the quantized transform coefficients based on the quantized transform coefficients in the 1D vector form.

An entropy encoder 240 may perform various encoding methods such as exponential Golomb, context-adaptive variable length coding (CAVLC), context-adaptive binary arithmetic coding (CABAC), etc. An entropy encoder 240 may encode information necessary for video/image reconstruction (e.g., a value of syntax elements, etc.) other than quantized transform coefficients together or separately.

Encoded information (ex. encoded video/image information) may be transmitted or stored in a unit of a network abstraction layer (NAL) unit in a bitstream form. The video/image information may further include information on various parameter sets such as an adaptation parameter set (APS), a picture parameter set (PPS), a sequence parameter set (SPS) or a video parameter set (VPS), etc. In addition, the video/image information may further include general constraint information. Herein, information and/or syntax elements transmitted/signaled from an encoding apparatus to a decoding apparatus may be included in video/image information. The video/image information may be encoded through the above-described encoding procedure and included in the bitstream. The bitstream may be transmitted through a network or may be stored in a digital storage medium. Here, a network may include a broadcasting network and/or a communication network, etc. and a digital storage medium may include various storage media such as USB, SD, CD, DVD, Blu-ray, HDD, SSD, etc. A transmission unit (not shown) for transmitting and/or a storage unit (not shown) for storing a signal output from an entropy encoder 240 may be configured as an internal/external element of an encoding apparatus 200, or a transmission unit may be also included in an entropy encoder 240.

Quantized transform coefficients output from a quantizer 233 may be used to generate a prediction signal. For example, a residual signal (a residual block or residual samples) may be reconstructed by applying dequantization and inverse transform to quantized transform coefficients through a dequantizer 234 and an inverse transformer 235. An adder 250 may add a reconstructed residual signal to a prediction signal output from an inter predictor 221 or an intra predictor 222 to generate a reconstructed signal (a reconstructed picture, a reconstructed block, a reconstructed sample array). When there is no residual for a block to be processed like when a skip mode is applied, a predicted block may be used as a reconstructed block. An adder 250 may be referred to as a reconstructor or a reconstructed block generator. A generated reconstructed signal may be used for intra prediction of a next block to be processed within a current picture, and may be also used for inter prediction of a next picture through filtering as described later. Meanwhile, luma mapping with chroma scaling (LMCS) may be applied in a picture encoding and/or reconstruction process.

A filter 260 may improve subjective/objective image quality by applying filtering to a reconstructed signal. For example, a filter 260 may generate a modified reconstructed picture by applying various filtering methods to a reconstructed picture, and may store the modified reconstructed picture in a memory 270, specifically in a DPB of a memory 270. The various filtering methods may include deblocking filtering, sample adaptive offset, adaptive loop filter, bilateral filter, etc. A filter 260 may generate various information on filtering and transmit it to an entropy encoder 240. Information on filtering may be encoded in an entropy encoder 240 and output in a form of a bitstream.

A modified reconstructed picture transmitted to a memory 270 may be used as a reference picture in an inter predictor 221. When inter prediction is applied through it, an encoding apparatus may avoid prediction mismatch in an encoding apparatus 200 and a decoding apparatus, and may also improve encoding efficiency.

A DPB of a memory 270 may store a modified reconstructed picture to use it as a reference picture in an inter predictor 221. A memory 270 may store motion information of a block from which motion information in a current picture is derived (or encoded) and/or motion information of blocks in a pre-reconstructed picture. The stored motion information may be transmitted to an inter predictor 221 to be used as motion information of a spatial neighboring block or motion information of a temporal neighboring block. A memory 270 may store reconstructed samples of reconstructed blocks in a current picture and transmit them to an intra predictor 222.

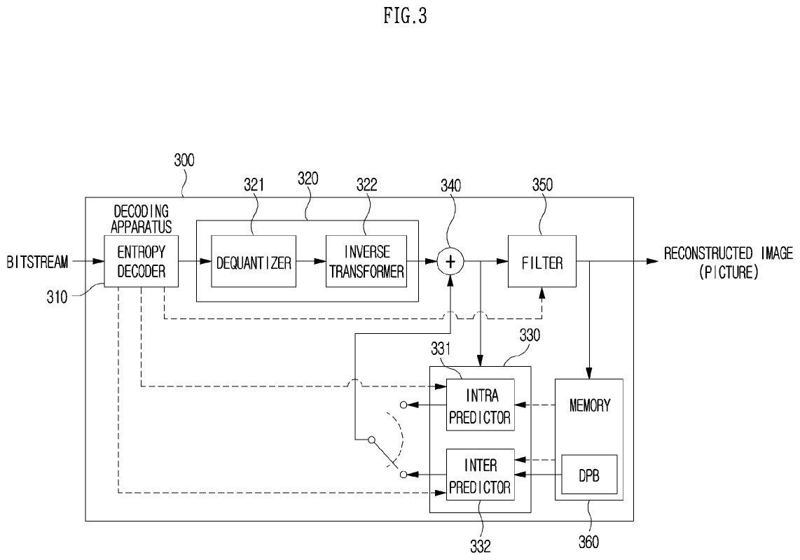

FIG. 3 shows a rough block diagram of a decoding apparatus to which an embodiment of the present disclosure may be applied and decoding of a video/image signal is performed.

Referring to FIG. 3, a decoding apparatus 300 may be configured by including an entropy decoder 310, a residual processor 320, a predictor 330, an adder 340, a filter 350 and a memory 360. A predictor 330 may include an inter predictor 332 and an intra predictor 331. A residual processor 320 may include a dequantizer 321 and an inverse transformer 321.

According to an embodiment, the above-described entropy decoder 310, residual processor 320, predictor 330, adder 340 and filter 350 may be configured by one hardware component (e.g., a decoder chipset or a processor). In addition, a memory 360 may include a decoded picture buffer (DPB) and may be configured by a digital storage medium. The hardware component may further include a memory 360 as an internal/external component.

When a bitstream including video/image information is input, a decoding apparatus 300 may reconstruct an image in response to a process in which video/image information is processed in an encoding apparatus of FIG. 2. For example, a decoding apparatus 300 may derive units/blocks based on block partition-related information obtained from the bitstream. A decoding apparatus 300 may perform decoding by using a processing unit applied in an encoding apparatus. Accordingly, a processing unit of decoding may be a coding unit, and a coding unit may be partitioned from a coding tree unit or the largest coding unit according to a quad tree structure, a binary tree structure and/or a ternary tree structure. At least one transform unit may be derived from a coding unit. And, a reconstructed image signal decoded and output through a decoding apparatus 300 may be played through a playback device.

A decoding apparatus 300 may receive a signal output from an encoding apparatus of FIG. 2 in a form of a bitstream, and a received signal may be decoded through an entropy decoder 310. For example, an entropy decoder 310 may parse the bitstream to derive information (ex. video/image information) necessary for image reconstruction (or picture reconstruction). The video/image information may further include information on various parameter sets such as an adaptation parameter set (APS), a picture parameter set (PPS), a sequence parameter set (SPS) or a video parameter set (VPS), etc. In addition, the video/image information may further include general constraint information. A decoding apparatus may decode a picture further based on information on the parameter set and/or the general constraint information. Signaled/received information and/or syntax elements described later herein may be decoded through the decoding procedure and obtained from the bitstream. For example, an entropy decoder 310 may decode information in a bitstream based on a coding method such as exponential Golomb encoding, CAVLC, CABAC, etc. and output a value of a syntax element necessary for image reconstruction and quantized values of a transform coefficient regarding a residual. In more detail, a CABAC entropy decoding method may receive a bin corresponding to each syntax element from a bitstream, determine a context model by using syntax element information to be decoded, decoding information of a neighboring block and a block to be decoded or information of a symbol/a bin decoded in a previous step, perform arithmetic decoding of a bin by predicting a probability of occurrence of a bin according to a determined context model and generate a symbol corresponding to a value of each syntax element. In this case, a CABAC entropy decoding method may update a context model by using information on a decoded symbol/bin for a context model of a next symbol/bin after determining a context model. Among information decoded in an entropy decoder 310, information on prediction is provided to a predictor (an inter predictor 332 and an intra predictor 331), and a residual value on which entropy decoding was performed in an entropy decoder 310, i.e., quantized transform coefficients and related parameter information may be input to a residual processor 320. A residual processor 320 may derive a residual signal (a residual block, residual samples, a residual sample array). In addition, information on filtering among information decoded in an entropy decoder 310 may be provided to a filter 350. Meanwhile, a reception unit (not shown) that receives a signal output from an encoding apparatus may be further configured as an internal/external element of a decoding apparatus 300 or a reception unit may be a component of an entropy decoder 310.

Meanwhile, a decoding apparatus according to this specification may be referred to as a video/image/picture decoding apparatus, and the decoding apparatus may be divided into an information decoder (a video/image/picture information decoder) and a sample decoder (a video/image/picture sample decoder). The information decoder may include the entropy decoder 310 and the sample decoder may include at least one of dequantizer 321, the inverse transformer 322, the adder 340, the filter 350, the memory 360, the inter predictor 332 and the intra predictor 331.

A dequantizer 321 may dequantize quantized transform coefficients and output transform coefficients. A dequantizer 321 may reorder quantized transform coefficients into a two-dimensional block form. In this case, the reordering may be performed based on coefficient scan order performed in an encoding apparatus. A dequantizer 321 may perform dequantization on quantized transform coefficients by using a quantization parameter (e.g., quantization step size information) and obtain transform coefficients.

An inverse transformer 322 inversely transforms transform coefficients to obtain a residual signal (a residual block, a residual sample array).

A predictor 320 may perform prediction on a current block and generate a predicted block including prediction samples for the current block. A predictor 320 may determine whether intra prediction or inter prediction is applied to the current block based on the information on prediction output from an entropy decoder 310 and determine a specific intra/inter prediction mode.

A predictor 320 may generate a prediction signal based on various prediction methods described later. For example, a predictor 320 may not only apply intra prediction or inter prediction for prediction for one block, but also may apply intra prediction and inter prediction simultaneously. It may be referred to as a combined inter and intra prediction (CIIP) mode. In addition, a predictor may be based on an intra block copy (IBC) prediction mode or may be based on a palette mode for prediction for a block. The IBC prediction mode or palette mode may be used for content image/video coding of a game, etc. such as screen content coding (SCC), etc. IBC basically performs prediction within a current picture, but it may be performed similarly to inter prediction in that it derives a reference block within a current picture. In other words, IBC may use at least one of inter prediction techniques described herein. A palette mode may be considered as an example of intra coding or intra prediction. When a palette mode is applied, information on a palette table and a palette index may be included in the video/image information and signaled.

An intra predictor 331 may predict a current block by referring to samples within a current picture. The samples referred to may be positioned in the neighborhood of the current block or may be positioned a certain distance away from the current block according to a prediction mode. In intra prediction, prediction modes may include at least one nondirectional mode and a plurality of directional modes. An intra predictor 331 may determine a prediction mode applied to a current block by using a prediction mode applied to a neighboring block.

An inter predictor 332 may derive a prediction block for a current block based on a reference block (a reference sample array) specified by a motion vector on a reference picture. In this case, in order to reduce the amount of motion information transmitted in an inter prediction mode, motion information may be predicted in a unit of a block, a sub-block or a sample based on the correlation of motion information between a neighboring block and a current block. The motion information may include a motion vector and a reference picture index. The motion information may further include inter prediction direction information (L0 prediction, L1 prediction, Bi prediction, etc.). For inter prediction, a neighboring block may include a spatial neighboring block existing in a current picture and a temporal neighboring block existing in a reference picture. For example, an inter predictor 332 may configure a motion information candidate list based on neighboring blocks and derive a motion vector and/or a reference picture index of the current block based on received candidate selection information. Inter prediction may be performed based on various prediction modes, and the information on prediction may include information indicating an inter prediction mode for the current block.

An adder 340 may add an obtained residual signal to a prediction signal (a prediction block, a prediction sample array) output from a predictor (including an inter predictor 332 and/or an intra predictor 331) to generate a reconstructed signal (a reconstructed picture, a reconstructed block, a reconstructed sample array). When there is no residual for a block to be processed like when a skip mode is applied, a prediction block may be used as a reconstructed block.

An adder 340 may be referred to as a reconstructor or a reconstructed block generator. A generated reconstructed signal may be used for intra prediction of a next block to be processed in a current picture, may be output through filtering as described later or may be used for inter prediction of a next picture. Meanwhile, luma mapping with chroma scaling (LMCS) may be applied in a picture decoding process.

A filter 350 may improve subjective/objective image quality by applying filtering to a reconstructed signal. For example, a filter 350 may generate a modified reconstructed picture by applying various filtering methods to a reconstructed picture and transmit the modified reconstructed picture to a memory 360, specifically a DPB of a memory 360. The various filtering methods may include deblocking filtering, sample adaptive offset, adaptive loop filter, bilateral filter, etc.

The (modified) reconstructed picture stored in the DPB of the memory 360 can be used as a reference picture in the inter predictor 332. A memory 360 may store motion information of a block from which motion information in a current picture is derived (or decoded) and/or motion information of blocks in a pre-reconstructed picture. The stored motion information may be transmitted to an inter predictor 332 to be used as motion information of a spatial neighboring block or motion information of a temporal neighboring block. A memory 360 may store reconstructed samples of reconstructed blocks in a current picture and transmit them to an intra predictor 331.

Herein, embodiments described in a filter 260, an inter predictor 221 and an intra predictor 222 of an encoding apparatus 200 may be also applied equally or correspondingly to a filter 350, an inter predictor 332 and an intra predictor 331 of a decoding apparatus 300, respectively.

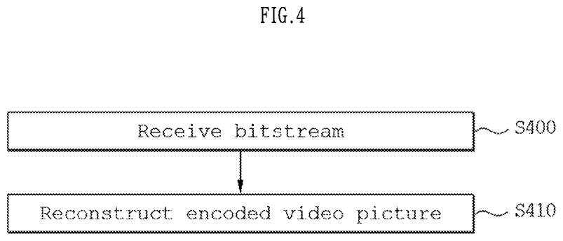

FIG. 4 illustrates a method for reconstructing a video picture performed by the decoding apparatus 300 according to the present disclosure.

A bitstream including an encoded video picture may be received S400.

The encoded video picture of a bitstream may be reconstructed S410.

Video information related to an encoded video picture may be extracted from a bitstream. An encoded video picture may be reconstructed based on extracted video information.

A bitstream may include AI usage restrictions (AUR). AI usage restrictions may signal a restriction on usage by an AI application and optional context information. AI usage restrictions may be configured in the supplemental enhancement information (SEI) message of a bitstream. In this case, AI usage restrictions may be named an AI usage restriction SEI message.

An AI usage restriction SEI message may be included in an SEI processing order (SPO) SEI message. It is to represent that a signaled usage restriction is applied to a post-processing result indicated in a corresponding SPO SEI message. When a signaled usage restriction is applied to a post-processed video but is not applied to a cropped decoded picture, an AI usage restriction SEI message may be included in a processing order nesting (PON) SEI message. It is possible to indicate the first set of usage restrictions applied to a cropped decoded picture by using a non-nested AI usage restriction SEI message and the second set of usage restrictions applied to a post-processed video by using an AI usage restriction SEI message included in a PON SEI message. In this case, the second set may include an additional usage restriction other than usage restrictions belonging to the first set.

(1) When an SPO SEI message exists, (2) an AI usage restriction SEI message is not included in a processing chain defined by a corresponding SPO SEI message and (3) an AI usage restriction SEI message not included in a PON SEI message exists, an indicated AI usage restriction may be applied to both a cropped decoded picture and a processing chain result.

When an SPO SEI message exists and an AI usage restriction SEI message not included in a PON SEI message exists, SEI message(s) related to a processing chain defined by an SPO SEI message must not contradict an indicated AI usage restriction. For example, a generative neural network may not be indicated simultaneously as a neural network post-filter (NNPF) within a processing chain and aur_restriction having a value of 2 (i.e., do not use for generative AI).

An AI usage restriction SEI message according to the present disclosure may be configured as in Table 1 below.

TABLE 1

| | Descriptor |
|---|---|
| ai_usage_restrictions ( payloadSize ) { | |
| aur_cancel_flag | u(1) |
| if( !aur_cancel_flag ) { | |
| aur_persistence_flag | u(1) |
| aur_num_restrictions_minus1 | ue(v) |
| for( i = 0; i <= aur_num_restrictions_minus1; i++ ) { | |
| aur_restriction[ i ] | ue(v) |
| aur_context_present_flag[ i ] | u(1) |
| if( aur_context_present_flag[ i ] ) | |
| aur_context[ i ] | ue(v) |
| } | |
| } | |

An AI usage restriction SEI message may include an AUR cancellation flag (aur_cancel_flag).

When aur_cancel_flag is 1, it may represent that an SEI message cancels the persistence of a previous AI usage restriction SEI message in an output order. When aur_cancel_flag is 0, it may represent that AI usage restrictions follow.

An AI usage restriction SEI message may include an AUR persistence flag (aur_persistence_flag).

aur_persistence_flag may represent the persistence of an AI usage restriction SEI message for a current layer. As an example, when aur_persistence_flag is 0, it may represent that an AI usage restriction SEI message is applied only to a current decoded picture. When aur_persistence_flag is 1, it may represent that an AI usage restriction SEI message is applied to a current decoded picture and persists for all subsequent pictures of a current layer in an output order until at least one of the following conditions 1 to 3 is true.
(Condition 1) The new coded layer video sequence (CLVS) of a current layer starts.
(Condition 2) A bitstream ends.
(Condition 3) A picture within the current layer of an access unit (AU) associated with an AI usage restriction SEI message is output after a current picture in an output order.

An AI usage restriction SEI message may include restriction number information (aur_num_restrictions_minus1).

aur_num_restrictions_minus1 may represent the number of restriction entries. As an example, a value obtained by adding 1 to aur_num_restrictions_minus1 may be set as the number of restriction entries.

An AI usage restriction SEI message may include AI usage restriction information (aur_restriction).

aur_restriction may specify one of the pre-defined restrictions. As an example, aur_restriction may specify a restriction defined in Table 2.

TABLE 2

| Value | Interpretation |
|---|---|
| 0 | Do not use in any AI application |
| 1 | Do not use for AI training |
| 2 | Do not use for generative (modification or creation) AI |
| 3 | Do not use for AI inference |

Referring to Table 2, aur_restriction with a value of 0 may represent that it may not be used in any AI application. aur_restriction with a value of 1 may represent that it may not be used for AI training. aur_restriction with a value of 2 may represent that it may not be used for generative AI. aur_restriction with a value of 3 may represent that it may not be used for AI inference. A value of aur_restriction may be restricted to be in the range of 0 to 3.

aur_restriction may be signaled as many as the number of restriction entries according to aur_num_restrictions_minus1.

An AI usage restriction SEI message may include a context presence flag (aur_context_present_flag).

aur_context_present_flag may represent whether context information for aur_restriction (aur_context) exists. As an example, when aur_context_present_flag is 1, it may represent that aur_context for aur_restriction exists, and when aur_context_present_flag is 0, it may represent that aur_context for aur_restriction does not exist. When aur_context_present_flag is 0, aur_restriction may be applied regardless of a context.

aur_context_present_flag may be signaled as many as the number of restriction entries according to aur_num_restrictions_minus1.

An AI usage restriction SEI message may include context information (aur_context).

aur_context may represent a context for aur_restriction. As an example, aur_context may be defined as in Table 3.

TABLE 3

| Bitmask | Interpretation |
|---|---|
| 0x0001 | commercial use |
| 0x0002 | non-commercial use |
| 0x0004 | official government use |
| 0x0008 | research and academic use |

When (aur_context & bitMask) is not 0, it may represent that corresponding aur_restriction is applied to a context corresponding to a bitMask value. When aur_context is greater than 0 and (aur_context & bitMask) is 0, the application of corresponding aur_restriction may not be defined in a context associated with a bitMask value. A value of aur_context may be restricted to be in the range of 1 to 15. aur_context may be restricted from having a value of 0. When aur_context is not signaled, it may be inferred that corresponding aur_restriction is applied regardless of a context.

aur_context may be signaled based on at least one of aur_num_restrictions_minus1 or aur_context_present_flag. aur_context may be signaled as many as the number of restriction entries according to aur_num_restrictions_minus1. aur_context may be signaled based on a value of aur_context_present_flag being 1, and may not be signaled based on a value of aur_context_present_flag being 0.

To apply an AI usage restriction SEI message according to the present disclosure to the AVC standard and the HEVC standard, the following matters need to be considered. The present disclosure must be interpreted and applied in a manner that an original intended function and purpose are maintained in the AVC standard and the HEVC standard. In addition, rules must be defined according to the structure of each standard to ensure proper application.

When rules for application to the AVC standard and the HEVC standard are not properly defined, the following problems may arise. When an SEI message is implemented in a manner inconsistent with an original intended purpose, a designated function may not be performed. In addition, when compatibility with other standards is not considered, future update and integration with a new technology may be hindered. Accordingly, it is necessary to clearly define rules between standards for the smooth application of the present disclosure.

To this end, the HEVC standard may define general SEI payload semantics for an AI usage restriction SEI message.

In the present disclosure, 225 may represent the value of a payload type for an AI usage restriction SEI message. In other words, based on the value of a payload type being 225, an AI usage restriction SEI message may be signaled from a bitstream. However, it is just an example, and another value, not 225, may also be used when it is a unique value representing the payload type of an AI usage restriction SEI message.

A predetermined list (SingleLayerSeiList) may be constructed with payload type values for SEI messages. Here, SingleLayerSeiList may relate to SEI messages associated with a single layer within a multi-layer bitstream. In this case, payload type values within SingleLayerSeiList may include a specific value representing a payload type for an AI usage restriction SEI message. Here, a specific value may be 225. However, values of 0 (buffering period), 1 (picture timing), 4 (user data registered by Recommendation ITU-T T.35), 5 (unregistered user data), 130 (decoding unit information) and 133 (scalable nesting) may be excluded from SingleLayerSeiList.

As an example, in D.3.1 General SEI payload semantics, SingleLayerSeiList may be defined as in Table 4 below.

TABLE 4
D.3.1 General SEI payload semantics

The list SingleLayerSeiList is set to consist of the payloadType values 2, 3, 6, 9, 15, 16, 17,
19, 22, 23, 45, 47, 56, 128, 129, 131, 132, 134 to 152, inclusive, 154 to 159, inclusive, 200
to 202, inclusive, 205, 210 to 212, inclusive, 216, 218, and 220 to 222, inclusive, and 225.

A predetermined list (VclAssociatedSeiList) may be constructed with payload type values for SEI messages. Here, VclAssociatedSeiList may relate to SEI messages associated with a video coding layer (VCL) NAL unit. VclAssociatedSeiList may be constructed with values of a payload type for SEI messages that infer constraints for the NAL unit header of an SEI NAL unit based on the NAL unit header of an associated VCL NAL unit (when included in a non-scalable-nested SEI NAL unit). In this case, payload type values within VclAssociatedSeiList may include a specific value representing a payload type for an AI usage restriction SEI message. Here, a specific value may be 225.

As an example, in D.3.1 General SEI payload semantics, VclAssociatedSeiList may be defined as in Table 5 below.

TABLE 5
D.3.1 General SEI payload semantics

The list VclAssociatedSeiList is set to consist of the payloadType values 2, 3, 6, 9, 15, 16,
17, 19, 22, 23, 45, 47, 56, 128, 131, 132, 134 to 152, inclusive, 154 to 159, inclusive, 200 to
202, inclusive, 205, 210 to 212, inclusive, 216, 218, and 220 to 222, inclusive, and 225.

As an example, in F.14.3.1 General SEI payload semantics, VclAssociatedSeiList may be defined as in Table 6 below.

TABLE 6
F.14.3.1 General SEI payload semantics

The list VclAssociatedSeiList is set to consist of the payloadType values 2, 3, 6, 9, 15, 16,
17, 19, 22, 23, 45, 47, 56, 128, 131, 132, 134 to 152, inclusive, 154 to 159, inclusive, 161,
165, 167, 168, 200 to 202, inclusive, 205, 210 to 212, inclusive, 216, 218, and 220 to 222,
inclusive, and 225.

As an example, in G.14.3.1 General SEI payload semantics, VclAssociatedSeiList may be defined as in Table 7 below.

TABLE 7
G.14.3.1 General SEI payload semantics

The list VclAssociatedSeiList is set to consist of payloadType values 2, 3, 6, 9, 15, 16, 17,
19, 22, 23, 45, 47, 56, 128, 131, 132, 134 to 152, inclusive, 154 to 159, inclusive, 161, 165,
167, 168, 177, 178, 179, 200 to 202, inclusive, 205, 210 to 212, inclusive, 216, 218, and 220
to 222, inclusive, and 225.

As an example, in I.14.3.1 General SEI payload semantics, VclAssociatedSeiList may be defined as in Table 8 below.

TABLE 8
I.14.3.1 General SEI payload semantics

The list VclAssociatedSeiList is set to consist of payloadType values 2, 3, 6, 9, 15, 16, 17,
19, 22, 23, 45, 47, 56, 128, 131, 132, 134 to 152, inclusive, 154 to 159, inclusive, 161, 165,
167, 168, 177, 178, 179, 200 to 202, inclusive, 205, 210 to 212, inclusive, 216, 218, and 220
to 222, inclusive, and 225.

A predetermined list (PicUnitRepConSeiList) may be constructed with payload type values for SEI messages. Here, PicUnitRepConSeiList may relate to SEI messages subject to specific picture unit representation constraints. PicUnitRepConSeiList may relate to SEI messages subject to eight repeated restrictions for each picture unit. In this case, payload type values within PicUnitRepConSeiList may include a specific value representing a payload type for an AI usage restriction SEI message. Here, a specific value may be 225.

As an example, in D.3.1 General SEI payload semantics, PicUnitRepConSeiList may be defined as in Table 9 below.

TABLE 9
D.3.1 General SEI payload semantics

The list PicUnitRepConSeiList is set to consist of the payloadType values 0, 1, 2, 6, 9, 15,
16, 17, 19, 22, 23, 45, 47, 56, 128, 129, 131, 132, 133, 135 to 152, inclusive, 154 to 159,
inclusive, 200 to 202, inclusive, 205, 210 to 212, inclusive, 216, 218, and 220 to 222,
inclusive, and 225.

As an example, in F.14.3.1 General SEI payload semantics, PicUnitRepConSeiList may be defined as in Table 10 below.

TABLE 10
F.14.3.1 General SEI payload semantics

The list PicUnitRepConSeiList is set to consist of the payloadType values 0, 1, 2, 6, 9, 15,
16, 17, 19, 22, 23, 45, 47, 56, 128, 129, 131, 132, 133, 135 to 152, inclusive, 154 to 168,
inclusive, 200 to 202, inclusive, 205, 210 to 212, inclusive, 216, 218, and 220 to 222,
inclusive, and 225.

As an example, in G.14.3.1 General SEI payload semantics, PicUnitRepConSeiList may be defined as in Table 11 below.

TABLE 11
G.14.3.1 General SEI payload semantics

The list PicUnitRepConSeiList is set to consist of payloadType values 0, 1, 2, 6, 9, 15, 16,
17, 19, 22, 23, 45, 47, 56, 128, 129, 131, 132, 133, 135 to 152, inclusive, 154 to 168,
inclusive, 176 to 180, inclusive, 200 to 202, inclusive, 205, 210 to 212, inclusive, 216, 218,
and 220 to 222, inclusive, and 225.

As an example, in I.14.3.1 General SEI payload semantics, PicUnitRepConSeiList may be defined as in Table 12 below.

TABLE 12
I.14.3.1 General SEI payload semantics

The list PicUnitRepConSeiList is set to consist of payloadType values 0, 1, 2, 6, 9, 15, 16,
17, 19, 22, 23, 45, 47, 56, 128, 129, 131, 132, 133, 135 to 152, inclusive, 154 to 168,
inclusive, 176 to 181, inclusive, 200 to 202, inclusive, 205, 210 to 212, inclusive, 216, 218,
and 220 to 222, inclusive, and 225.

In addition, the AVC standard may define SEI payload semantics for an AI usage restriction SEI message.

As an example, SEI payload semantics may be defined as in Table 13 below.

TABLE 13
F.13.2 SEI payload semantics

The semantics of the SEI messages with payloadType in the range of 0 to 23, inclusive, or
equal to 45, 47, 137, 142, 144, 147, 148, 149, 150, 151, 154, 155, 156, 200, 201, 202, 205,
210, 211, 212, 218, or 225, which are specified in clause D.2, are extended as follows:
If payloadType is equal to 3, 8, 19, 20, or 22, the following applies:
If the SEI message is not included in a scalable nesting SEI message, it applies to
the layer representations of the current access unit that have dependency_id equal to
0 and quality_id equal to 0.
The semantics as specified in clause D.2 apply to the bitstream that would be
obtained by invoking the bitstream extraction process as specified in clause F.8.8.1
with dIdTarget equal to 0 and qIdTarget equal to 0. All syntax elements and derived
variables that are referred to in the semantics in clause D.2 are syntax elements and
variables for layer representations with dependency_id equal to 0 and quality_id
equal to 0. All SEI messages that are referred to in clause D.2 are SEI messages that
apply to layer representations with dependency_id equal to 0 and quality_id equal
to 0.
Otherwise (the SEI message is included in a scalable nesting SEI message), the SEI
message applies to all layer representations of the current access unit for which
DQId is equal to any value of
( ( sei_dependency_id[i] << 4 ) + sei_quality_id[ i ] ) with i in the range of 0 to
num_layer_representations_minus1, inclusive.
For each value of i in the range of 0 to num_layer_representations_minus1,
inclusive, the semantics as specified in clause D.2 apply to the bitstream that would
be obtained by invoking the bitstream extraction process as specified in
clause F.8.8.1 with dIdTarget equal to sei_dependency_id[ i ] and qIdTarget equal to
sei_quality_id[ i ]. All syntax elements and derived variables that are referred to in
the semantics in clause D.2 are syntax elements and variables for layer
representations with dependency_id equal to sei_dependency_id[ i ] and quality_id
equal to sei_quality_id[ i ]. All SEI messages that are referred to in clause D.2 are
SEI messages that apply to layer representations with dependency_id equal to
sei_dependency_id[ i ] and quality_id equal to sei_quality_id[ i ].
Otherwise, if payloadType is equal to 2, 6, 7, 9, 10, 11, 12, 13, 14, 15, 16, 17, 18, 21, 23,
45, 47, 137, 142, 144, 147, 148, 149, 150, 151, 154, 155, 156, 200, 201, 202, 205, 210,
211, 212, 218, or 225, the following applies:
If the SEI message is not included in a scalable nesting SEI message, it applies to
the dependency representations of the current access unit that have dependency_id
equal to 0.
The semantics as specified in clause D.2 apply to the bitstream that would be
obtained by invoking the bitstream extraction process as specified in clause F.8.8.1
with dIdTarget equal to 0. All syntax elements and derived variables that are referred
to in the semantics in clause D.2 are syntax elements and variables for dependency
representations with dependency_id equal to 0. All SEI messages that are referred
to in clause D.2 are SEI messages that apply to dependency representations with
dependency_id equal to 0.
Otherwise (the SEI message is included in a scalable nesting SEI message), the
scalable nesting SEI message containing the SEI message shall have
all_layer_representations_in_au_flag equal to 1 or, when
all_layer_representations_in_au_flag is equal to 0, all values of sei_quality_id[ i ]
present in the scalable nesting SEI message shall be equal to 0. The SEI message
that is included in the scalable nesting SEI message applies to all dependency
representations of the current access unit for which dependency_id is equal to any
value of sei_dependency_id[ i ] with i in the range of 0 to
num_layer_representations_minus1, inclusive.
For each value of i in the range of 0 to num_layer_representations_minus1,
inclusive, the semantics as specified in clause D.2 apply to the bitstream that would
be obtained by invoking the bitstream extraction process as specified in
clause F.8.8.1 with dIdTarget equal to sei_dependency_id[ i ]. All syntax elements
and derived variables that are referred to in the semantics in clause D.2 are syntax
elements and variables for dependency representations with dependency_id equal to
sei_dependency_id[ i ]. All SEI messages that are referred to in clause D.2 are SEI
messages that apply to dependency representations with dependency_id equal to
sei_dependency_id[ i ].
When payloadType is equal to 10 for the SEI message that is included in a scalable
nesting SEI message, the semantics for sub_seq_layer_num of the sub-sequence
information SEI message is modified as follows:
sub_seq_layer_num specifies the sub-sequence layer number of the current
picture. When the current picture resides in a sub-sequence for which the first
picture in decoding order is an IDR picture, the value of sub_seq_layer_num
shall be equal to 0. For a non-paired reference field, the value of
sub_seq_layer_num shall be equal to 0. sub_seq_layer_num shall be in the range
of 0 to 255, inclusive.
Otherwise, if payloadType is equal to 0 or 1, the following applies:
If the SEI message is not included in a scalable nesting SEI message, the following
applies. When the SEI message and all other SEI messages with payloadType equal
to 0 or 1 not included in a scalable nesting SEI message are used as the buffering
period and picture timing SEI messages for checking the bitstream conformance
according to Annex C and the decoding process specified in clauses 2 to 9 is used,
the bitstream shall be conforming to this Recommendation | International Standard.
The value of seq_parameter_set_id in a buffering period SEI message not included
in a scalable nesting SEI message shall be equal to the value of
seq_parameter_set_id in the picture parameter set that is referenced by the layer
representation with DQId equal to 0 of the primary coded picture in the same access
unit.
Otherwise (the SEI message is included in a scalable nesting SEI message), the
following applies. When the SEI message and all other SEI messages with
payloadType equal to 0 or 1 included in a scalable nesting SEI message with
identical values of sei_temporal_id, sei_dependency_id[ i ], and sei_quality_id[ i ]
are used as the buffering period and picture timing SEI messages for checking the
bitstream conformance according to Annex C, the bitstream that would be obtained
by invoking the bitstream extraction process as specified in clause F.8.8.1 with
tIdTarget equal to sei_temporal_id, dIdTarget equal to sei_dependency_id[ i ], and
qIdTarget equal to sei_quality_id[ i ] shall be conforming to this
Recommendation | International Standard.
In the semantics of clauses D.2.1 and D.2.3, the syntax elements num_units_in_tick,
time scale, fixed_frame_rate_flag, nal_hrd_parameters_present_flag,
vcl_hrd_parameters_present_flag, low_delay_hrd_flag, and pic_struct_present_flag
and the derived variables NalHrdBpPresentFlag, VclHrdBpPresentFlag, and
CpbDpbDelaysPresentFlag are substituted with the syntax elements
vui_ext_num_units_in_tick[ i ], vui_ext_time_scale[ i ],
vui_ext_fixed_frame_rate_flag[ i ], vui_ext_nal_hrd_parameters_present_flag[ i ],
vui_ext_vcl_hrd_parameters_present_flag[ i ], vui_ext_low_delay_hrd_flag[ i ],
and vui_ext_pic_struct_present_flag[ i ] and the derived variables
VuiExtNalHrdBpPresentFlag[ i ], VuiExtVclHrdBpPresentFlag[ i ], and
VuiExtCpbDpbDelaysPresentFlag[ i ].
The value of seq_parameter_set_id in a buffering period SEI message included in a
scalable nesting SEI message with the values of sei_dependency_id[ i] and
sei_quality_id[ i ] shall be equal to the value of seq_parameter_set_id in the picture
parameter set that is referenced by the layer representation with DQId equal to
(( sei_dependency_id[ i ] << 4 ) + sei_quality_id[ i ]) of the primary coded picture
in the same access unit.
Otherwise (payloadType is equal to 4 or 5), the corresponding SEI message semantics
are not extended.
When an SEI message having a particular value of payloadType equal to 137 or 144,
contained in a scalable nesting SEI message, and applying to a particular combination of
dependency_id, quality_id, and temporal_id is present in an access unit, the SEI message
with the particular value of payloadType applying to the particular combination of
dependency_id, quality_id, and temporal_id shall be present a scalable nesting SEI message
in the IDR access unit that is the first access unit of the coded video sequence.
All SEI messages having a particular value of payloadType equal to 137 or 144, contained
in scalable nesting SEI messages, and applying to a particular combination of
dependency_id, quality_id, and temporal_id present in a coded video sequence shall have
the same content.
For the semantics of SEI messages with payloadType in the range of 0 to 23, inclusive, or
equal to 45, 47, 137, 142, 144, 147, 148, 149, 150, 151, 154, 155, 156, 200, 201, 202, 205,
210, 211, 212,218, or 225, which are specified in clause D.2, SVC sequence parameter set is
substituted for sequence parameter set; the parameters of the picture parameter set RBSP and
SVC sequence parameter set RBSP that are in effect are specified in clause F.7.4.1.2.1.
Coded video sequences conforming to one or more of the profiles specified in Annex F shall
not include SEI NAL units that contain SEI messages with payloadType in the range of 36
to 44, inclusive, or equal to 46, which are specified in clause G.13, or with payloadType in
the range of 48 to 53, inclusive, which are specified in clause H.13.
When an SEI NAL unit contains an SEI message with payloadType in the range of 24 to 35,
inclusive, which are specified in clause F.13, it shall not contain any SEI message that has
payloadType less than 24 or equal to 45, 47, 137, 142, 144, 147, 148, 149, 150, 151, 154,
155, 156, 200, 201, 202, 205, 210, 211, 212, 218, or 225, that is not included in a scalable
nesting SEI message, and the first SEI message in the SEI NAL unit shall have payloadType
in the range of 24 to 35, inclusive.
When an SEI NAL unit contains an SEI message with payloadType equal to 24, 28, or 29, it
shall not contain any SEI message with payloadType not equal to 24, 28, or 29.
When a scalable nesting SEI message (payloadType is equal to 30) is present in an SEI NAL
unit, it shall be the only SEI message in the SEI NAL unit.
The semantics for SEI messages with payloadType in the range of 24 to 35, inclusive, are
specified in the following.

In the present disclosure, 225 may represent the value of a payload type for an AI usage restriction SEI message. In other words, based on the value of a payload type being 225, an AI usage restriction SEI message may be decoded from a bitstream. However, it is just an example, and another value, not 225, may also be used when it is a unique value representing the payload type of an AI usage restriction SEI message.

Referring to Table 13, when the value of a payload type is 225 (i.e., when the value of a payload type represents an AI usage restriction SEI message), based on whether a corresponding AI usage restriction SEI message is included in a scalable nesting SEI message, it may be determined to which dependency representations of a current access unit (AU) a corresponding AI usage restriction SEI message is applied.

Specifically, when an AI usage restriction SEI message is not included in a scalable nesting SEI message, a corresponding AI usage restriction SEI message may be applied to the dependency representations of a current AU having a dependency identifier (dependency_id) of 0. On the other hand, when an AI usage restriction SEI message is included in a scalable nesting SEI message, a corresponding AI usage restriction SEI message may be applied to all dependency representations of a current AU having the same dependency identifier as an SEI dependency identifier (sei_dependency_id). An SEI dependency identifier may be explicitly signaled through a bitstream.

A different type of SEI message may be restricted from being included within an SEI NAL unit. Referring to Table 13, when an SEI NAL unit includes an SEI message having a payload type within the range of 24 to 35 specified in Section F.13, a corresponding SEI NAL unit may be restricted from including an AI usage restriction SEI message corresponding to a payload type of 225 (not included in a scalable nesting SEI message). The first SEI message of a corresponding SEI NAL unit may be restricted to have a payload type within the range of 24 to 35. Here, a payload type within the range of 24 to 35 may be a scalable video coding (SVC)-related SEI message.

In other words, an AI usage restriction SEI message may be restricted from being included in the same SEI NAL unit as an SVC-related SEI message. However, when an AI usage restriction SEI message is included within a scalable nesting SEI message, an AI usage restriction SEI message may be exceptionally included in the same SEI NAL unit as an SVC-related SEI message.

An AI usage restriction SEI message according to the present disclosure may be included in the network abstraction layer (NAL) unit of a bitstream. Alternatively, AI usage restrictions according to the present disclosure may be configured in the high-level syntax of a bitstream. Here, a high-level syntax may be at least one of a sequence parameter set (SPS), a picture parameter set (PPS), a picture header (PH) or a slice header (SH). Alternatively, AI usage restrictions according to the present disclosure may also be defined as a separate NAL unit type within a bitstream.

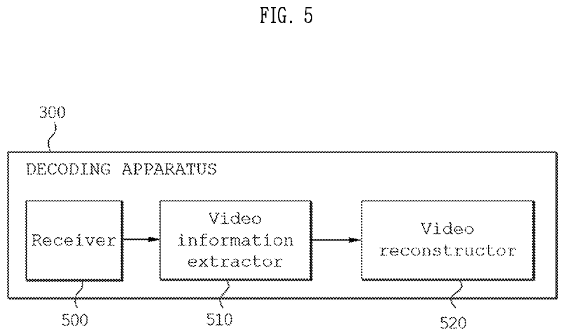

FIG. 5 illustrates a schematic configuration of the decoding apparatus 300 that performs a method for reconstructing a video picture according to the present disclosure.

Referring to FIG. 5, the decoding apparatus 300 may include the receiver 500, the video information extractor 510 and the video reconstructor 520.

The receiver 500 may receive a bitstream including an encoded video picture.

The video information extractor 510 may extract video information related to an encoded video picture from a bitstream. In addition, the video information extractor 710 may extract AI usage restrictions from a bitstream, which is the same as described by referring to FIG. 4.

The video reconstructor 520 may reconstruct an encoded video picture based on extracted video information.

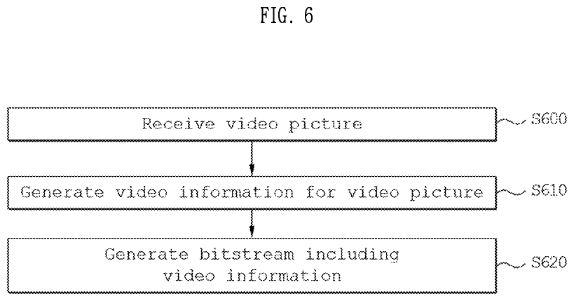

FIG. 6 illustrates a method for generating a bitstream performed by the encoding apparatus 200 according to the present disclosure.

An encoded video picture may be received S600.

A received video picture may be encoded to generate video information related to a video picture S610.

A bitstream including video information related to a video picture may be generated S620.

In addition, AI usage restrictions applied to a bitstream may be generated, which is the same as described by referring to FIG. 4. The generated AI usage restrictions may be included in a bitstream. In this case, AI usage restrictions may be configured in the SEI message of a bitstream and may also be configured in the high-level syntax of a bitstream.

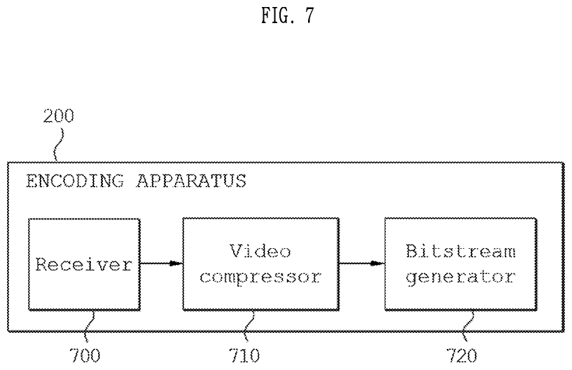

FIG. 7 illustrates a schematic configuration of the encoding apparatus 200 that performs a method for generating a bitstream according to the present disclosure.

Referring to FIG. 7, the encoding apparatus 200 may include the receiver 700, the video compressor 710 and the bitstream generator 720.

The receiver 700 may receive one or more video pictures encoded.

The video compressor 710 may encode one or more received video pictures to generate video information related to a video picture. The video compressor 710 may generate AI usage restrictions applied to a bitstream.

The bitstream generator 720 may generate a bitstream including the video information. The bitstream generator 720 may generate a bitstream further including the generated AI usage restrictions.

In the above-described embodiment, methods are described based on a flowchart as a series of steps or blocks, but a corresponding embodiment is not limited to the order of steps, and some steps may occur simultaneously or in different order with other steps as described above. In addition, those skilled in the art may understand that steps shown in a flowchart are not exclusive, and that other steps may be included or one or more steps in a flowchart may be deleted without affecting the scope of embodiments of the present disclosure.

The above-described method according to embodiments of the present disclosure may be implemented in a form of software, and an encoding apparatus and/or a decoding apparatus according to the present disclosure may be included in a device which performs image processing such as a TV, a computer, a smartphone, a set top box, a display device, etc.

In the present disclosure, when embodiments are implemented as software, the above-described method may be implemented as a module (a process, a function, etc.) that performs the above-described function. A module may be stored in a memory and may be executed by a processor. A memory may be internal or external to a processor, and may be connected to a processor by a variety of well-known means. A processor may include an application-specific integrated circuit (ASIC), another chipset, a logic circuit and/or a data processing device. A memory may include a read-only memory (ROM), a random access memory (RAM), a flash memory, a memory card, a storage medium and/or another storage device. In other words, embodiments described herein may be performed by being implemented on a processor, a microprocessor, a controller or a chip. For example, functional units shown in each drawing may be performed by being implemented on a computer, a processor, a microprocessor, a controller or a chip. In this case, information for implementation (ex. information on instructions) or an algorithm may be stored in a digital storage medium.

In addition, a decoding apparatus and an encoding apparatus to which embodiment(s) of the present disclosure are applied may be included in a multimedia broadcasting transmission and reception device, a mobile communication terminal, a home cinema video device, a digital cinema video device, a surveillance camera, a video conversation device, a real-time communication device like a video communication, a mobile streaming device, a storage medium, a camcorder, a device for providing video on demand (VOD) service, an over the top video (OTT) device, a device for providing Internet streaming service, a three-dimensional (3D) video device, a virtual reality (VR) device, an augmented reality (AR) device, a video phone video device, a transportation terminal (ex. a vehicle (including an autonomous vehicle) terminal, an airplane terminal, a ship terminal, etc.) and a medical video device, etc., and may be used to process a video signal or a data signal. For example, an over the top video (OTT) device may include a game console, a blu-ray player, an Internet-connected TV, a home theater system, a smartphone, a tablet PC, a digital video recorder (DVR), etc.

In addition, a processing method to which embodiment(s) of the present disclosure are applied may be produced in a form of a program executed by a computer and may be stored in a computer-readable recording medium. Multimedia data having a data structure according to embodiment(s) of the present disclosure may be also stored in a computer-readable recording medium. The computer-readable recording medium includes all types of storage devices and distributed storage devices that store computer-readable data. The computer-readable recording medium may include, for example, a blu-ray disk (BD), an universal serial bus (USB), ROM, PROM, EPROM, EEPROM, RAM, CD-ROM, a magnetic tape, a floppy disk and an optical media storage device. In addition, the computer-readable recording medium includes media implemented in a form of a carrier wave (e.g., transmission via the Internet). In addition, a bitstream generated by an encoding method may be stored in a computer-readable recording medium or may be transmitted through a wired or wireless communication network.

In addition, embodiment(s) of the present disclosure may be implemented by a computer program product by a program code, and the program code may be executed on a computer by embodiment(s) of the present disclosure. The program code may be stored on a computer-readable carrier.

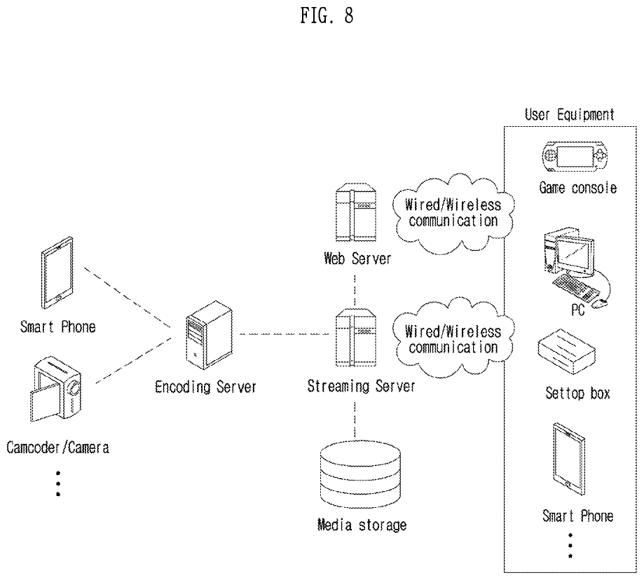

FIG. 8 shows an example of a contents streaming system to which embodiments of the present disclosure may be applied.

Referring to FIG. 8, a contents streaming system to which embodiment(s) of the present disclosure are applied may largely include an encoding server, a streaming server, a web server, a media storage, a user device and a multimedia input device.

The encoding server generates a bitstream by compressing contents input from multimedia input devices such as a smartphone, a camera, a camcorder, etc. into digital data and transmits it to the streaming server. As another example, when multimedia input devices such as a smartphone, a camera, a camcorder, etc. directly generate a bitstream, the encoding server may be omitted.

The bitstream may be generated by an encoding method or a bitstream generation method to which embodiment(s) of the present disclosure are applied, and the streaming server may temporarily store the bitstream in a process of transmitting or receiving the bitstream.

The streaming server transmits multimedia data to a user device based on a user's request through a web server, and the web server serves as a medium to inform a user of what service is available. When a user requests desired service from the web server, the web server delivers it to a streaming server, and the streaming server transmits multimedia data to a user. In this case, the contents streaming system may include a separate control server, and in this case, the control server controls a command/a response between each device in the content streaming system.

The streaming server may receive contents from a media storage and/or an encoding server. For example, when contents is received from the encoding server, the contents may be received in real time. In this case, in order to provide smooth streaming service, the streaming server may store the bitstream for a certain period of time.

An example of the user device may include a mobile phone, a smart phone, a laptop computer, a digital broadcasting terminal, a personal digital assistants (PDAs), a portable multimedia players (PMP), a navigation, a slate PC, a Tablet PC, an ultrabook, a wearable device (e.g., a smartwatch, a smart glass, a head mounted display (HMD), a digital TV, a desktop, a digital signage, etc.

Each server in the contents streaming system may be operated as a distributed server, and in this case, data received from each server may be distributed and processed.

The claims set forth herein may be combined in various ways. For example, a technical characteristic of a method claim of the present disclosure may be combined and implemented as a device, and a technical characteristic of a device claim of the present disclosure may be combined and implemented as a method. In addition, a technical characteristic of a method claim of the present disclosure and a technical characteristic of a device claim may be combined and implemented as a device, and a technical characteristic of a method claim of the present disclosure and a technical characteristic of a device claim may be combined and implemented as a method.

What is claimed is:

1. A method, comprising:
receiving a bitstream including an encoded video picture; and
reconstructing the encoded video picture included in the bitstream,
wherein the bitstream includes an artificial intelligence (AI) usage restriction supplemental enhancement information (SEI) message,
wherein the AI usage restriction SEI message includes AI usage restriction information representing a restriction on AI usage and context information representing a context for the AI usage restriction information, and
wherein the AI usage restriction SEI message is obtained from a network abstraction layer (NAL) unit of the bitstream.

2. The method of claim 1, wherein a predetermined list is constructed with payload type values for SEI messages, and
wherein the payload type values within the list include a specific value representing a payload type for the AI usage restriction SEI message.

3. The method of claim 2, wherein the specific value representing the payload type for the AI usage restriction SEI message is 225.

4. The method of claim 3, wherein the list is related to SEI messages associated with a single layer within a multi-layer bitstream.

5. The method of claim 3, wherein the list is related to SEI messages associated with a video coding layer (VCL) NAL unit.

6. The method of claim 3, wherein the list is related to SEI messages subject to specific picture unit representation constraints.

7. The method of claim 1, wherein based on whether the AI usage restriction SEI message is included in a scalable nesting SEI message, it is determined to which dependency representations of a current access unit (AU) the AI usage restriction SEI message is applied.

8. The method of claim 7, wherein based on the AI usage restriction SEI message not being included in the scalable nesting SEI message, the AI usage restriction SEI message is applied to dependency representations of the current AU having a dependency identifier of 0, and
wherein based on the AI usage restriction SEI message being included in the scalable nesting SEI message, the AI usage restriction SEI message is applied to dependency representations of the current AU having a same dependency identifier as an SEI dependency identifier signaled through the bitstream.

9. The method of claim 1, wherein the AI usage restriction SEI message is restricted from being included in a same SEI NAL unit as a scalable video coding-related SEI message.

10. A method, comprising:
receiving a video picture to be encoded;
encoding the received video picture to generate video information related to the video picture;
generating an artificial intelligence (AI) usage restriction supplemental enhancement information (SEI) message; and
generating a bitstream including the video information and the AI usage restriction SEI message,
wherein the AI usage restriction SEI message includes AI usage restriction information representing a restriction on AI usage and context information representing a context for the AI usage restriction information, and
wherein the AI usage restriction SEI message is encoded in a network abstraction layer (NAL) unit of the bitstream.

11. A non-transitory computer-readable storage medium for storing a bitstream generated by the method according to claim 10.

12. A method, comprising:
generating a bitstream, wherein the bitstream is generated based on receiving a video picture to be encoded, encoding the received video picture to generate video information related to the video picture, and generating an artificial intelligence (AI) usage restriction supplemental enhancement information (SEI) message; and
transmitting data including the bitstream,
wherein the AI usage restriction SEI message includes AI usage restriction information representing a restriction on AI usage and context information representing a context for the AI usage restriction information, and
wherein the AI usage restriction SEI message is encoded in a network abstraction layer (NAL) unit of the bitstream.
